(19) United States
(12) Patent Application Publication
(10) Pub. No.: US 2023/0245210 A1
(43) Pub. Date: Aug. 3, 2023

(54) KNOWLEDGE GRAPH-BASED INFORMATION RECOMMENDATION

(71) Applicant: Tencent Technology (Shenzhen) Company Limited, Shenzhen (CN)

(72) Inventors: Li YANG, Shenzhen (CN); Shijia E, Shenzhen (CN)

(73) Assignee: Tencent Technology (Shenzhen) Company Limited, Shenzhen (CN)

(21) Appl. No.: 18/132,846

(22) Filed: Apr. 10, 2023

Related U.S. Application Data
(63) Continuation of application No. PCT/CN2022/100862, filed on Jun. 23, 2022.

(30) Foreign Application Priority Data
Jul. 16, 2021 (CN) 202110805059.8

(51) Int. Cl. G06Q 30/0601; G06N 20/00

(52) U.S. Cl. CPC G06Q 30/0631; G06N 20/00

(57) ABSTRACT

An account entity relation between a target account entity and a neighbor account entity is obtained. An item entity relation between a target item entity and a neighbor item entity is obtained. The account entity relation is converted into an account relation embedding vector. The item entity relation is converted into an item relation embedding vector. Under supervision of a target item embedding vector, a target account embedding vector and a neighbor account embedding vector are fused through the account relation embedding vector into a target account representation. Under supervision of a target account embedding vector, a target item embedding vector and a neighbor item embedding vector are fused through the item relation embedding vector into a target item representation. A target item for a target account of the target account entity is determined from the target item entity based on the target account representation and the target item representation.

### RELATED APPLICATIONS

The present application is a continuation of International Application No. PCT/CN2022/100862, entitled “INFORMATION RECOMMENDATION METHOD AND APPARATUS BASED ON KNOWLEDGE GRAPH, AND DEVICE, MEDIUM, AND PRODUCT” and filed on Jun. 23, 2022, which claims priority to Chinese Patent Application No. 202110805059.8, entitled “KNOWLEDGE GRAPH-BASED INFORMATION RECOMMENDATION METHOD AND APPARATUS, DEVICE, MEDIUM, AND PRODUCT” and filed on Jul. 16, 2021. The entire disclosures of the prior applications are hereby incorporated by reference in their entirety.

### FIELD OF THE TECHNOLOGY

This disclosure relates to the field of machine learning, including graph-based information recommendation.

### BACKGROUND OF THE DISCLOSURE

With the explosive growth of information, a recommendation system plays an increasingly important role in various online platforms. The recommendation system can learn potential interest preferences of users from user profiles or historical interaction records, thereby performing personalized recommendation on target commodities of interest for the users.

A knowledge graph embedding model may be trained to process knowledge triplets in a knowledge graph by knowledge graph embedding (the knowledge triplets are usually represented by “entity-relation-entity”, for example, the knowledge triplets are “user 1-friend-user 2”). The knowledge triplets include an entity and an entity relation. The entity and the entity relation are respectively mapped into an entity low-dimensional vector and an entity relation low-dimensional vector according to distance similarity. Then the foregoing entity low-dimensional vector and entity relation low-dimensional vector are converted into recommendation scores, and recommended commodities are determined through the ranking of the recommendation scores.

However, only low-order information in the knowledge graph may be analyzed, and the accuracy of a recommended commodity result obtained according to the low-order information may be low, resulting in repeated execution of a prediction process and waste of computing resources.

### SUMMARY

Embodiments of this disclosure provide a knowledge graph-based information recommendation method and apparatus, a device, a non-transitory computer-readable storage medium, and a product. The following technical solution are included.

According to an aspect of the disclosure, a method of knowledge graph-based information recommendation is provided. In the method, an account entity relation between a target account entity and a neighbor account entity of the target account entity is obtained from a knowledge graph. An item entity relation between a target item entity and a neighbor item entity of the target item entity is obtained. The target account entity and the neighbor account entity are included in a plurality of account entities, and the target item entity and the neighbor item entity are included in a plurality of item entities. The plurality of account entities is converted into a plurality of account embedding vectors, the account entity relation is converted into an account relation embedding vector, the plurality of item entities is converted into a plurality of item embedding vectors, and the item entity relation is converted into an item relation embedding vector. Based on a target item embedding vector of the plurality of item embedding vectors associated with the target item entity, a target account embedding vector of the plurality of account embedding vectors associated with the target account entity and a neighbor account embedding vector of the plurality of account embedding vectors associated with the neighbor account entity are fused through the account relation embedding vector to obtain a target account representation. Based on the target account embedding vector of the plurality of account embedding vectors associated with the target account entity, the target item embedding vector of the plurality of item embedding vectors associated with the target item entity and a neighbor item embedding vector of the plurality of item embedding vectors associated with the neighbor item entity are fused through the item relation embedding vector to obtain a target item representation. Based on a distance between the target account representation and the target item representation, a target item for a target account of the target account entity is determined from the target item entity, where the distance indicates a degree of matching between the target account and the determined target item.

According to another aspect of the disclosure, an apparatus is provided. The apparatus includes processing circuitry. The processing circuitry can be configured to perform any of the described methods for knowledge graph-based information recommendation.

Aspects of the disclosure also provide a non-transitory computer-readable medium storing instructions which when executed by a computer for video decoding cause the computer to perform any of the described methods for knowledge graph-based information recommendation.

The beneficial effects brought about by the technical solutions provided in embodiments of this disclosure at least include two exemplary aspects as follows:

In an aspect, a target user account representation is obtained through a target user account embedding vector and a neighbor user account embedding vector, and a target commodity representation is obtained through a target commodity embedding vector and a neighbor commodity embedding vector. The target user account representation obtained thereby includes both features of a target user account and features of a neighbor user account. Likewise, the target commodity representation includes both the features of the target commodity and the features of the neighbor commodity. Therefore, the target user account representation and the target commodity representation are more expressive, and can better express the features of the target user account and the target commodity, so that the accuracy of a recommendation result thus obtained is better.

In an aspect, feature vectors extracted in the embodiments of this disclosure can improve the expression ability of accounts and commodities, thereby increasing the number of times of commodity recommendation hits, avoiding the waste of data resources caused by requiring multiple recommendation analyses, improving the efficiency of commodity recommendation, and reducing the problem of increasing the amount of data interaction caused by low accuracy of commodity recommendation between computer devices.

### BRIEF DESCRIPTION OF THE DRAWINGS

FIG. 1 is a schematic structural diagram of a computer system according to an exemplary embodiment of this disclosure.

FIG. 2 is a schematic diagram of a commodity recommendation model according to an exemplary embodiment of this disclosure.

FIG. 3 is a schematic flowchart of a knowledge graph-based information recommendation method according to an exemplary embodiment of this disclosure.

FIG. 4 is a schematic diagram of a knowledge graph according to an exemplary embodiment of this disclosure.

FIG. 5 is a schematic diagram of a single attention information propagation and aggregation sub-network layer according to an exemplary embodiment of this disclosure.

FIG. 6 shows a schematic flow of calculating a target user account representation according to an exemplary embodiment of this disclosure.

FIG. 7 is a sub-diagram of a knowledge graph user account side according to an exemplary embodiment of this disclosure.

FIG. 8 shows a schematic flow of calculating a target commodity representation according to an exemplary embodiment of this disclosure.

FIG. 9 is a sub-diagram of a knowledge graph commodity side according to an exemplary embodiment of this disclosure.

FIG. 10 is a schematic flowchart of a pre-training convolutional network method according to an exemplary embodiment of this disclosure.

FIG. 11 is a schematic flowchart of a trained commodity recommendation model method according to an exemplary embodiment of this disclosure.

FIG. 12 is a schematic flowchart of an exemplary knowledge graph-based information recommendation method according to an exemplary embodiment of this disclosure.

FIG. 13 is a schematic diagram of a knowledge graph-based information recommendation apparatus according to an exemplary embodiment of this disclosure.

FIG. 14 is a schematic structural diagram of a computer device according to an exemplary embodiment of this disclosure.

### DESCRIPTION OF EMBODIMENTS

First, examples of the nouns involved in the embodiments of this disclosure are described as follows:

Knowledge Graph includes, for example, a series of different graphs to display a relation between knowledge development process and structure, describing knowledge resources and their carriers using a visualization technology, and mining, analyzing, constructing, drawing, and displaying knowledge and relations thereof. The knowledge graph includes entities, relations, and attributes, where the relations are used for representing associations of the entities, and the attributes are used for representing inherent attributes of the entities.

Neighbor Entity includes, for example in the knowledge graph, entities connected by relations are referred to as neighbor entities, where the relations include both direct and indirect relations. Therefore, corresponding entity neighbors may include both direct and indirect neighbor entities.

Commodity (also referred to as item) may represent a labor product for interaction, where the labor product may be a tangible product, an intangible service, or a virtual product. For example, the commodity (or item) may be a tangible product such as an electronic product, food, or office supplies, an intangible service such as an insurance product or a financial product, or a virtual product such as a video or an electronic picture.

With the research and progress of an artificial intelligence technology, the artificial intelligence technology is researched and applied in many fields, such as common smart home, intelligent wearable devices, virtual assistants, intelligent speakers, intelligent marketing, unmanned driving, automatic driving, unmanned aerial vehicles, robots, intelligent medical, and intelligent customer service. It is believed that with the development of technology, the artificial intelligence technology will be applied in more fields and play an increasingly important value.

In a commodity recommendation scenario, there are typically a user account entity set [symbol] ={u₁, u₂, . . . , u_{M}} and a commodity entity set [symbol] ={i₁, i₂, . . . , i_{N}}. Historical interaction data for user account u and commodity i is represented by using a matrix Y∈R^{M×N} In the matrix, yᵤᵢ=1 means that there is an interactive record between the user account u and the commodity i, otherwise yᵤᵢ=0. Furthermore, a knowledge graph including an entity set ε={e₁, e₂, . . . , e_{S}} and a relation set [symbol] ={r₁, r₂, . . . , r_{T}} is defined as [symbol] ={(h, r, t)|h, t∈E, r∈ [symbol] }, where E represent an entity, and [symbol] represents an entity relation. In [symbol] , each valid triplet (h, r, t) represents that there is an entity relation r between a head entity h and a tail entity t. In the knowledge graph under the recommendation scenario, a user account and a commodity are parts of the entity, namely [symbol] ∈ε and [symbol] ∈ε. In an embodiment, the valid triplet includes at least one of a user account entity triplet (user account entity-user account entity relation-user account entity), a commodity entity triplet (commodity entity-commodity entity relation-commodity entity), and a user account-commodity interaction triplet (user account entity-user account commodity entity relation-commodity entity, or commodity entity-user account commodity entity relation-user account entity). Given a user account-commodity interaction matrix Y and a user account-commodity unified knowledge graph [symbol] , a commodity recommendation model of this application aims to learn a prediction function [symbol] in equation (1) as follows:

ŷᵤᵢ= [symbol] (u,i|Θ,Y, [symbol] ) Eq. (1)

where Θ is a parameter of the commodity recommendation model, and ŷᵤᵢ represents a probability predicted by the model. The probability is a probability that the user account u may generate an interactive behavior with the commodity i that has never interacted with. In other words, ŷᵤᵢ is a matching score between the user account u and the commodity i. A higher matching score represents that the user account u may be more likely interested in the commodity i and the commodity i may be more likely recommended to the user account u.

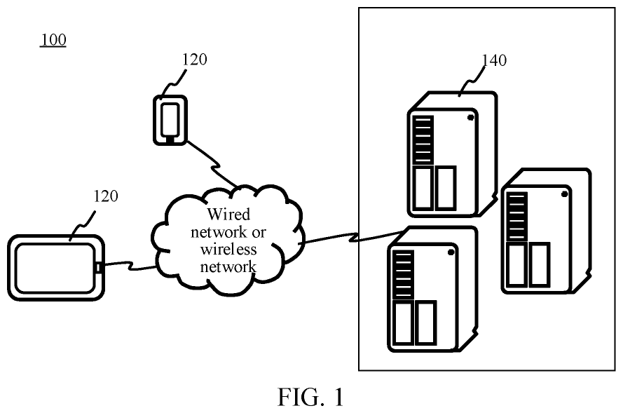

FIG. 1 shows a schematic structural diagram of a computer system according to an exemplary embodiment of this disclosure. A computer system 100 includes: a terminal 120 and a server 140.

The terminal 120 is installed with an application related to commodity recommendation. The application may be an applet in an app (application), or a specialized application, or a web client. Exemplarily, a user queries the terminal 120 for a recommended commodity, or the terminal 120 receives information of the recommended commodity transmitted by the server. The terminal 120 is at least one of a smart phone, a tablet computer, an e-book reader, an MP3 player, an MP4 player, a laptop portable computer, and a desktop computer.

The terminal 120 is connected to the server 140 through a wireless network or a wired network.

The server 140 may be an independent physical server, a server cluster or a distributed system composed of a plurality of physical servers, or a cloud server providing basic cloud computing services, such as a cloud service, a cloud database, cloud computing, a cloud function, cloud storage, a network service, cloud communication, a middleware service, a domain name service, a security service, a content delivery network (CDN), and big data and artificial intelligence platforms. The server 140 is configured to provide a background service for an application of commodity recommendation, and transmits a result of commodity recommendation to the terminal 120. In an example, the server 140 undertakes the primary computing work, and the terminal 120 undertakes the secondary computing work; or, the server 140 undertakes the secondary computing work, and the terminal 120 undertakes the primary computing work; or, the server 140 and the terminal 120 perform cooperative computing by using a distributed computing architecture.

Information (including but not limited to user equipment information, user personal information, and the like), data (including but not limited to data used for analysis, stored data, displayed data, and the like), and signals involved in this disclosure are authorized by the user alone or fully authorized by all parties, and the collection, use and processing of relevant data shall comply with relevant laws, regulations and standards of relevant countries and regions. For example, user account data involved in this disclosure is obtained with sufficient authorization.

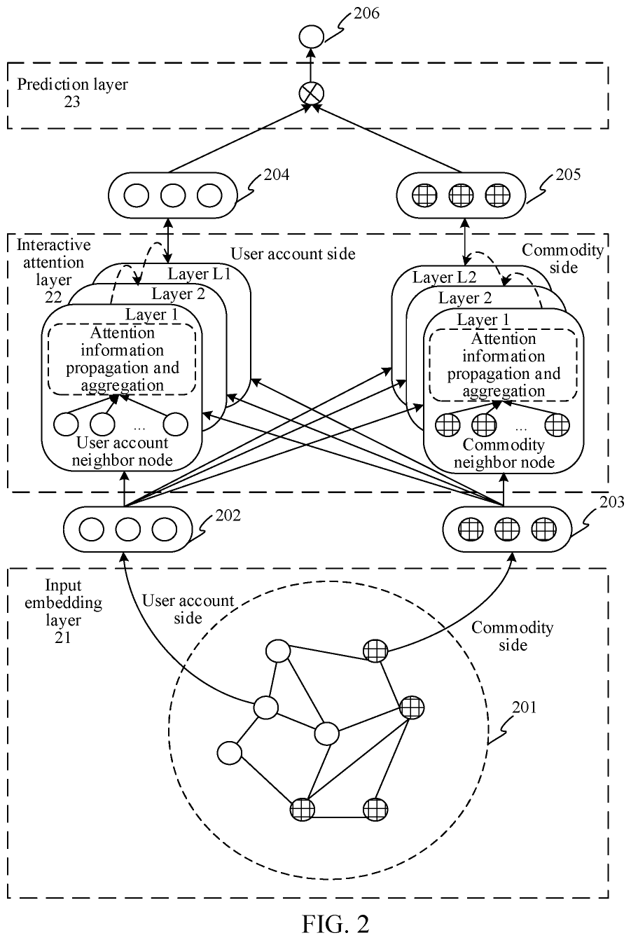

FIG. 2 shows a schematic diagram of a commodity recommendation model according to an exemplary embodiment of this disclosure. The commodity recommendation model includes: an input embedding layer 21, an interactive attention layer 22, and a prediction layer 23.

The input embedding layer 21 is configured to extract an entity embedding vector and an entity relation embedding vector from a knowledge graph. The entity embedding vector includes an account embedding vector and a commodity embedding vector. The entity relation embedding vector includes an account relation embedding vector, a commodity relation embedding vector, and an account-commodity relation embedding vector. The input embedding layer 21 inputs a knowledge graph 201, and outputs the account embedding vector and the commodity embedding vector (for the simplicity of the commodity recommendation model, FIG. 2 shows an account embedding vector 202 and a commodity embedding vector 203, and the account relation embedding vector, the commodity relation embedding vector, and the account-commodity relation embedding vector are also outputted by the input embedding layer 21). In an example, the input embedding layer 21 is implemented by at least one of a convolutional embedding (ConvE) model, a convolutional knowledge base (ConvKB) model, a relational-graph convolutional network (R-GCN) model, and a convolutional relation (ConvR) model.

The interactive attention layer 22 is configured to obtain account representations and commodity representations through an interactive attention mechanism. The interactive attention layer 22 inputs an entity embedding vector and an entity relation embedding vector (for the simplicity of the commodity recommendation model, FIG. 2 shows the account embedding vector 202 and the commodity embedding vector 203, and outputs an account representation 204 and a commodity representation 205. The interactive attention layer 22 includes a plurality of attention information propagation and aggregation sub-network layers. Exemplarily, an account side includes L₁ attention information propagation and aggregation sub-network layers. L₁ represents the neighbor depth of the account. For an i^{th} attention information propagation and aggregation sub-network layer, the account embedding vector and the commodity embedding vector 203 outputted by an i−1^{th} attention information propagation and aggregation sub-network layer are inputted, and the account embedding vector is outputted. Exemplarily, a commodity side includes L₂ attention information propagation and aggregation sub-network layers. L₂ represents the neighbor depth of the commodity. For an i^{th} attention information propagation and aggregation sub-network layer, the commodity embedding vector and the account embedding vector 202 outputted by an attention information propagation and aggregation sub-network layer are inputted, and the commodity embedding vector is outputted.

The prediction layer 23 is configured to calculate a recommendation score according to the account representation and the commodity representation. The prediction layer 23 inputs the account representation 204 and the commodity representation 205, and outputs a recommendation score 206. In an example, the recommendation score is calculated by using at least one of a dot product operation and cosine similarity calculation.

The foregoing account entity may be implemented as a user account entity, namely an account entity operated and used by a user. All account entities involved in this embodiment of this disclosure may be implemented as user account entities. In this embodiment of this disclosure, the account entity and the user account entity are used as the same meaning, and details will be omitted herein.

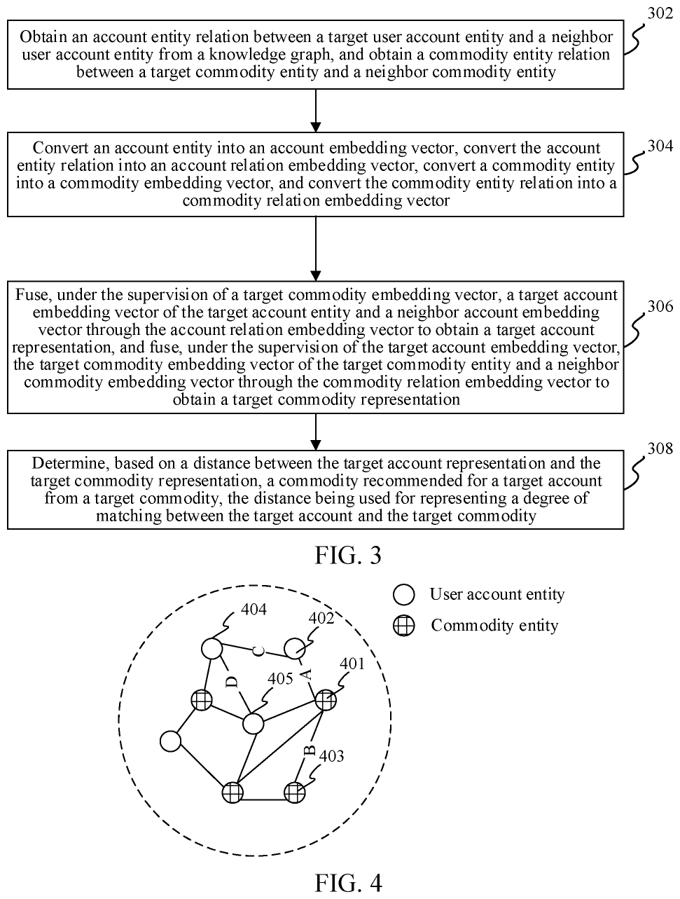

FIG. 3 shows a schematic flowchart of a knowledge graph-based information recommendation method according to an exemplary embodiment of this disclosure. The method may be performed by the terminal 120 or the server 140 or another computer device shown in FIG. 1. The method includes the following steps:

In step 302, an account entity relation between a target account entity and a neighbor account entity is obtained from a knowledge graph, and a commodity entity relation (or an item entity relation) between a target commodity entity (or a target item entity) and a neighbor commodity entity (or a neighbor item entity) is obtained.

The target account entity may be one or more accounts. The target account may be a target user account.

The target commodity entity may be one or more commodities (or items).

The knowledge graph includes account entities and commodity entities (or item entities). The account entities include a target account entity and a neighbor account entity. The target account entity is any one or more account entities in the account entities, and the neighbor account entity is a direct neighbor entity or an indirect neighbor entity of the target account entity. That is, there is a direct connection or indirect connection relation between the target account entity and the neighbor account entity in the knowledge graph. In an example, the connection relation between the account entities represents that there is an account association relation between the account entities. For example, if there is a direct connection relation between account 1 and account 2, a friend relation is established between account 1 and account 2, or account 1 and account 2 are in the same group, or there is another association relation therebetween. Accordingly, the commodity entities include a target commodity entity and a neighbor commodity entity. The target commodity entity is any one or more commodity entities in the commodity entities, and the neighbor commodity entity is a direct neighbor entity or an indirect neighbor entity of the target commodity entity. That is, there is a direct connection or indirect connection relation between the target commodity entity and the neighbor commodity entity in the knowledge graph. In an example, the connection relation between the commodity entities represents that there is a commodity association relation between the commodity entities. For example, if there is a direct connection relation between commodity 3 and commodity 4, commodity 3 and commodity 4 belong to the same store, or commodity 3 and commodity 4 belong to the same category, or there is another association relation therebetween.

In an example, there is an account-commodity relation between the account entity and the commodity entity. In an example, the connection relation between the account entity and the commodity represents that there is an option association relation between the commodity entities. For example, if there is a connection relation between account 1 and commodity 3, account 1 has chosen commodity 3 in a purchase history, or account 1 has placed commodity 3 in a shopping cart in the purchase history, or there is another association relation therebetween.

Exemplarily, as shown in FIG. 4, there is no direct entity relation between account entity 402 and account entity 405. However, there is an entity relation C between account entity 402 and account entity 404, and there is an entity relation D between account entity 404 and account entity 405. Therefore, account entity 402 establishes an indirect relation with account entity 405 through account 404, so that account entity 405 is an indirect neighbor entity of account entity 402.

Exemplarily, as shown in FIG. 4, the knowledge graph includes an account entity and a commodity entity. There is a commodity entity relation B between commodity entity 401 and commodity entity 403, and there is an account-commodity relation A between commodity entity 401 and account entity 402.

In this embodiment of this disclosure, the commodity represents a labor product for interaction, where the labor product may be a tangible product, an intangible service, or a virtual product. For example, the commodity may be a tangible product such as an electronic product, food, or office supplies, an intangible service such as an insurance product or a financial product, or a virtual product such as a video or an electronic picture.

In step 304, an account entity is converted into an account embedding vector, the account entity relation is converted into an account relation embedding vector, a commodity entity is converted into a commodity embedding vector, and the commodity entity relation is converted into a commodity relation embedding vector.

The account embedding vector is an embedding vector corresponding to the account entity. The account relation embedding vector is an embedding vector corresponding to the account entity relation.

The commodity embedding vector is an embedding vector corresponding to the commodity entity. The commodity relation embedding vector is an embedding vector corresponding to the commodity entity relation.

In an example, in this embodiment of this disclosure, a convolutional network is invoked to convert, through a vector searching operation, the account entity and the account entity relation into the account embedding vector and the account relation embedding vector and to convert the commodity entity and the commodity entity relation into the commodity embedding vector and the commodity relation embedding vector. The vector searching operation is used for searching for the corresponding embedding vectors according to the entities and/or the entity relations.

Exemplarily, the convolutional network is invoked to: search for the account embedding vector in a vector storage module according to the account entity through the vector searching operation; search for the account relation embedding vector in the vector storage module according to the account entity relation; search for the commodity embedding vector in the vector storage module according to the commodity entity; and search for the commodity relation embedding vector in the vector storage module according to the commodity entity relation. The vector storage module stores at least one of an entity-embedding vector correspondence and an entity relation-embedding vector correspondence.

In an example, the structure of the convolutional network includes at least one of a ConvE model, a ConvKB model, an R-GCN model, or a ConvR model. The specific structure of the convolutional network is not limited in this disclosure.

In step 306, under the supervision of (or based on) a target commodity embedding vector, a target account embedding vector of the target account entity and a neighbor account embedding vector associated with the neighbor account entity are fused through the account relation embedding vector to obtain a target account representation. The supervision of the target commodity embedding vector can indicate a vector range associated the target account embedding vector and/or the neighbor account embedding vector that is applied to the fusing process. Under the supervision of (or based on) the target account embedding vector, the target commodity embedding vector of the target commodity entity and a neighbor commodity embedding vector are fused through the commodity relation embedding vector into a target commodity representation. The supervision of the target account embedding vector can indicate a vector range associated the target commodity embedding vector and/or the neighbor commodity embedding vector that is applied to the fusing process.

That is, the target account embedding vector corresponding to the target account entity and the neighbor account embedding vector corresponding to the neighbor account entity are fused to obtain the target account representation, and the target commodity embedding vector corresponding to the target commodity entity and the neighbor commodity embedding vector corresponding to the neighbor commodity entity are fused to obtain the target commodity representation.

The target account representation includes features of the target account and features of the neighbor account.

The target commodity representation includes features of the target commodity and features of the neighbor commodity.

In an example, in an iterative manner, the target account representation and the target commodity representation are obtained through attention information propagation and information aggregation. Since the target account entity receives information from the indirect neighbor account entity and the indirect neighbor commodity entity as the iteration proceeds, the target account representation and the target commodity representation include high-order structured information in the knowledge graph.

In step 308, based on a distance between the target account representation and the target commodity representation, a commodity recommended for a target account is determined from a target commodity, where the distance indicates a degree of matching between the target account and the target commodity.

In an example, the distance between the target account representation and the target commodity representation is calculated to obtain a recommendation score. The recommendation score is used for representing the degree of matching between the target account and the target commodity. A recommended commodity for the target account is determined from the target commodity according to the recommendation score.

In an example, the distance between the target account representation and the target commodity representation is calculated through a dot product operation. Exemplarily, eᵤ is used to represent the target account representation, and eᵢ is used to represent the target commodity representation. Then the matching score is ŷᵤᵢ=σ(eᵤ^{T}eᵢ), where σ(⋅) represents a Sigmoid (sigmoid growth curve) function.

In an example, the recommendation score falls within an interval (0, 1).

In an example, cosine similarity of the target account representation and the target commodity representation is calculated to obtain the recommendation score.

In an example, a target commodity having the recommendation score greater than a score threshold is determined as the recommended commodity for the target account from the target commodity. Exemplarily, the score threshold is set as 0.5, and a commodity having the recommendation score greater than 0.5 is determined as the recommended commodity from the target commodity.

In an example, the recommended commodity for the target account is determined from the target commodity according to an arrangement order of the recommendation score. Exemplarily, a recommendation score of target commodity A is 0.2, a recommendation score of target commodity B is 0.9, a recommendation score of target commodity C is 0.45, a recommendation score of target commodity D is 0.7, and a recommendation score of target commodity E is 0.3. Then the target commodities are arranged in descending order of the recommendation scores to obtain “target commodity B-target commodity D-target commodity C-target commodity E-target commodity A”, and the first two target commodities in the ranking are taken as recommended commodities. The recommended commodities obtained are target commodity B and target commodity D.

In conclusion, in this embodiment, a target account representation is obtained through a target account embedding vector and a neighbor account embedding vector, and a target commodity representation is obtained through a target commodity embedding vector and a neighbor commodity embedding vector. The target account representation obtained thereby includes both features of a target account and features of a neighbor account. Likewise, the target commodity representation includes both the features of the target commodity and the features of the neighbor commodity. Therefore, the target account representation and the target commodity representation are more expressive, and can better express the features of the target account and the target commodity, so that the accuracy of a recommendation result thus obtained is better. According to the method provided in this embodiment, a convolutional network is invoked, and an account entity, an account entity relation, a commodity entity, and a commodity entity relation are converted into an embedding vector form through a vector searching operation, so as to facilitate subsequent analysis and improve data processing efficiency.

According to the method provided in this embodiment, commodities recommended for a user account are determined according to a score threshold, so as to improve commodity recommendation efficiency. It may be determined whether to recommend the commodities for the user account based on matching with the score threshold, so as to facilitate analysis and calculation. The commodities recommended for the user account are determined according to an arrangement order without separate calculation of all commodities. The commodities recommended for the user account may be determined by ranking all the commodities according to recommendation scores, thereby improving recommendation efficiency.

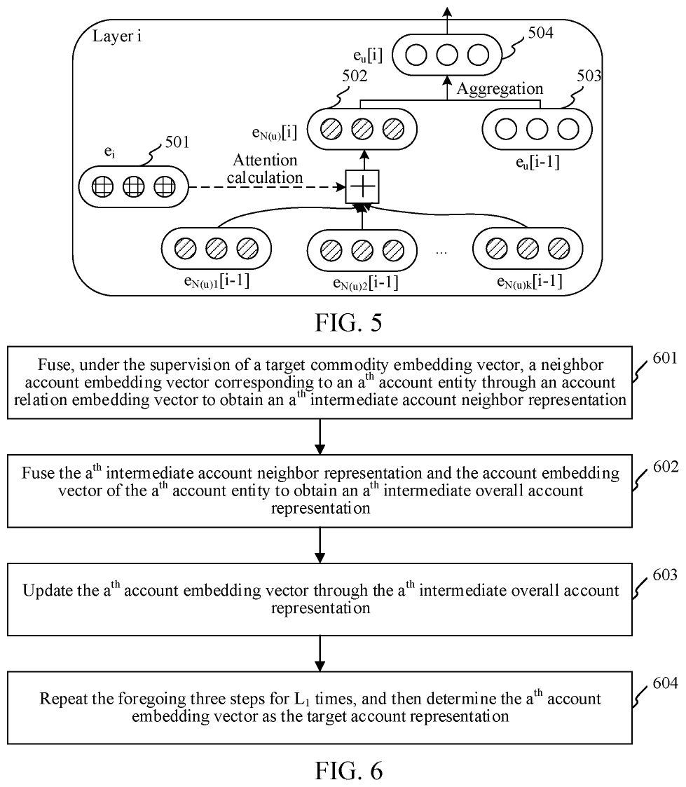

FIG. 5 shows a schematic diagram of a single attention information propagation and aggregation sub-network layer according to an exemplary embodiment of this disclosure. In FIG. 5, a single attention information propagation and aggregation sub-network layer on an account side is taken as an example. First, [symbol] , [symbol] , . . . , [symbol] represent direct neighbor account embedding vectors corresponding to direct neighbor accounts of account u in an i^{th} (i represents the number of attention information propagation and aggregation sub-network layers) attention information propagation and aggregation sub-network layer, where [symbol] (u) represents a set of direct neighbor accounts, and k is the total number of the direct neighbor accounts. The direct neighbor account embedding vectors and a target commodity embedding vector 501 are used to obtain an overall representation 502 of the direct neighbor account embedding vectors through an attention calculation mechanism. The target commodity embedding vector 501 is represented as eᵢ, and the overall representation 502 is represented as [symbol] . Then, the overall representation 502 and an account representation 503 of account entity u are subjected to aggregated calculation to obtain an account representation 504, and the account representation 504 is propagated to an i+1^{th} attention information propagation and aggregation sub-network layer. The account representation 503 is eᵤ[i−1] (the content in square brackets represents the number of attention information propagation and aggregation sub-network layers), and the account representation 504 is eᵤ[i].

In the following embodiment, an exemplary method for calculating a target account representation is provided. Information from neighbor account entities is selectively aggregated through an interactive attention mechanism, and the target account representation is continuously updated through an iterative method, so that a target account entity can receive more comprehensive neighbor account information. Therefore, on an account side, each account entity n∈ [symbol] ^{u}[l] (the symbol in square brackets represents the number of iterations) selectively aggregates a direct neighbor account entity embedding vector {e_{n′}^{u}[l−1]|n′∈ [symbol] (n)} ( [symbol] (n) represents a set of direct neighbor account entities of account entity n) from the account entity n under the supervision of a target commodity embedding vector eᵢ, to obtain [symbol] . After information propagation, an account embedding vector eₙ^{u}[l−1] and a neighbor account embedding vector [symbol] are aggregated to obtain a value to be used in the next iteration.

FIG. 6 shows a schematic flow of calculating a target account representation according to an exemplary embodiment of this disclosure. The method may be performed by the terminal 120 or the server 140 or another computer device shown in FIG. 1. The method includes the following steps:

In step 601, under the supervision of a target commodity embedding vector, a neighbor account embedding vector corresponding to an a^{th} account entity is fused through an account relation embedding vector to obtain an a^{th} intermediate account neighbor representation.

The a^{th} account entity is any one account entity in a knowledge graph.

In this embodiment, the neighbor account embedding vector corresponding to the fused a^{th} account entity may be a whole neighbor account embedding vector or a partial neighbor account embedding vector.

In this embodiment, a target account embedding vector includes: an a^{th} account embedding vector, where a is a positive integer.

In an example, the a^{th} account entity includes j direct neighbor account entities, and the j direct neighbor account entities have a direct relation with the a^{th} account entity, where j is a natural number. This step includes the following sub-steps:

In sub-step 1, for the a^{th} account entity in the knowledge graph, a feature interaction is performed on the target commodity embedding vector and the j direct neighbor account embedding vectors through the account relation embedding vector, to obtain j account attention scores.

In an example, n is used to represent the direct neighbor account entity, u is used to represent the a^{th} account entity, i is used to represent a target commodity, r_{u,n} is used to represent a relation between the a^{th} account entity and the direct neighbor account entity, and the account attention score is shown in equation (2):

$$γ ( {e}_{n} , {e}_{{r}_{u , n}} , {e}_{i} ) = {( {e}_{i} + {e}_{{r}_{u , n}} )}^{T} {e}_{n} \qquad Eq . ( 2 )$$

where eᵢ represents the target commodity embedding vector, eᵣ_{_{u,n}} represents the account relation embedding vector, and eₙ represents the direct neighbor account embedding vector.

In an example, the j account attention scores are normalized to obtain j normalized account attention scores.

Exemplarily, the normalized account attention score is shown in equation (3):

$$α ( {e}_{n} , {e}_{{r}_{u , n}} , {e}_{i} ) = \frac{exp ( γ ( {e}_{n} , {e}_{{r}_{u , n}} , {e}_{i} ) )}{{\sum }_{n ∈ 𝒩 ( u )} exp ( γ ( {e}_{n} , {e}_{{r}_{u , {n}^{′}}} , {e}_{i} ) )} \qquad Eq . ( 3 )$$

where γ(eₙ, eᵣ_{_{u,n}}, eᵢ) represents a non-normalized attention score, [symbol] (u)={n|(u, r_{u,n}, n)∈ [symbol] }, [symbol] (u) represents a set of the j direct neighbor account entities, [symbol] represents the knowledge graph, and exp( ) represents an exponential function based on a natural logarithm e.

In sub-step 2, a weighted combination is performed on the j account attention scores and the j direct neighbor account embedding vectors to obtain the a^{th} intermediate account neighbor representation.

The a^{th} intermediate account neighbor representation is used for representing an overall representation of the direct neighbor account entities of the a^{th} account entity.

In an example, weighted combination is performed on the j normalized account attention scores and the j direct neighbor account embedding vectors to obtain the a^{th} intermediate account neighbor representation.

Exemplarily, weighted combination is performed on the j normalized account attention scores and the j direct neighbor account embedding vectors to obtain the a^{th} intermediate account neighbor representation, which can be shown in equation (4):

[symbol]

= [symbol] α(eₙ,eᵣ_{_{u,n}},eᵢ)eₙ Eq. (4)

where eₙ represents the direct neighbor account embedding vector, and α(eₙ, eᵣ_{_{u,n}}, eᵢ) is the normalized account attention score corresponding to eₙ.

In step 602, the a^{th} intermediate account neighbor representation and the account embedding vector of the a^{th} account entity are fused to obtain an a^{th} intermediate overall account representation.

The a^{th} intermediate overall account representation is used for representing a temporary account representation of the a^{th} account entity when the iterative process has not ended.

In an example, the a^{th} intermediate account neighbor representation and the a^{th} account embedding vector are fused to obtain the a^{th} intermediate overall account representation through an aggregator.

Exemplarily, the a^{th} intermediate overall account representation is shown in equation (5):

eᵤ= [symbol] =tanh(W(gᵤ⊙eᵤ+(1−gᵤ) [symbol] )+b) Eq. (5)

where agg( ) represents a gating aggregator, eᵤ represents the a^{th} account embedding vector, W and b in the formula are a weight parameter and a bias parameter respectively, [symbol] represents the a^{th} intermediate account neighbor representation, ⊙ represents an element-wise multiplication operation, gᵤ∈R^{d} is a gating vector, and d is a dimension of the embedding vector. Further, gᵤ=σ( [symbol] +b_{g}), where [;] represents a connection operation, W_{g}∈R^{d×d} and b_{g}∈R^{d} are used for calculating a weight and bias of the gating vector, and σ(⋅) represents a Sigmoid function.

In step 603, the a^{th} account embedding vector is updated through the a^{th} intermediate overall account representation.

In an example, the a^{th} account embedding vector is replaced with the a^{th} intermediate overall account representation.

In step 604, the foregoing three steps can be repeated for L₁ times, and then the a^{th} account embedding vector is determined as the target account representation.

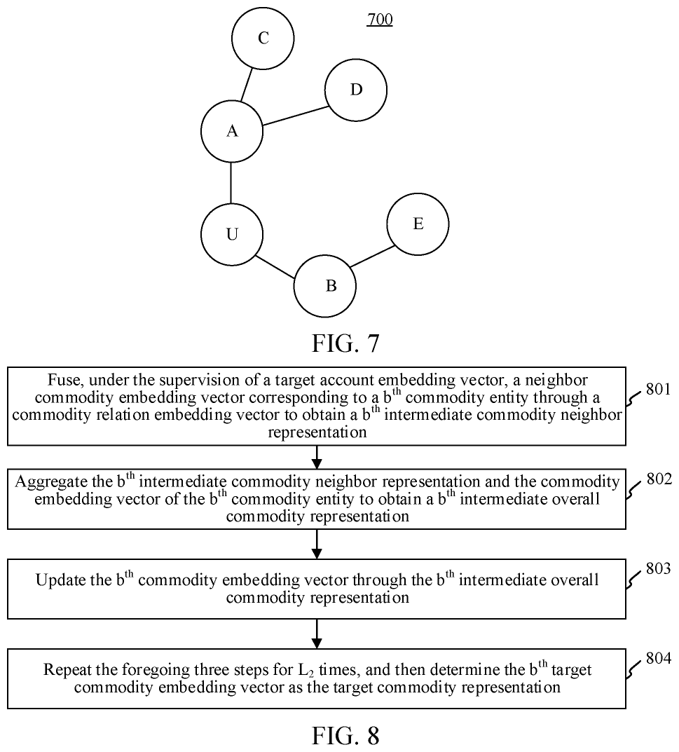

L₁ is an integer greater than or equal to a neighbor depth of the target account entity. Exemplarily, as shown in FIG. 7, account entity U serves as the target account entity, account entity A and account entity B are the direct neighbor account entities of account entity U, account entity C, account entity D, and account entity E are the indirect neighbor account entities of account entity U, and the neighbor depth is 2.

Exemplarily, as shown in FIG. 7, in a knowledge graph 700, account entity U serves as the target account entity. It is first determined that the knowledge graph further includes account entity A, account entity B, account entity C, account entity D, and account entity E.

Then in the first iteration, (1) the direct neighbor account entities of account entity U are account entity A and account entity B, information aggregation is performed on account entity A and account entity B, and the aggregated information is re-aggregated into account entity U. (2) The direct neighbor account entities of account entity A are account entity C and account entity D, information aggregation is performed on account entity C and account entity D, and the aggregated information is re-aggregated into account entity A. (3) Likewise, the direct neighbor account entity of account entity B is account entity E, and information of account entity E is directly aggregated into account entity B. Therefore, after the first iteration is completed, account entity U includes information of account entity U, information of account entity A, and information of account entity B. Account entity A includes the information of account entity A, information of account entity C, and information of account entity D. Account entity B includes the information of account entity B and information of account entity E.

In the second iteration, information aggregation is mainly performed on account entity A and account entity B, and the aggregated information is re-aggregated into account entity U. Since account entity A further includes the information of account entity C and account entity D and account entity B further includes the information of account entity E after the first iteration is completed, the information of account entity C, the information of account entity D, and the information of account entity E are all transferred into account entity U after the second iteration is completed. Therefore, after the second iteration is completed, account entity U includes not only the information of account U, but also the information of account entity A, account entity B, account entity C, account entity D, and account entity E.

In conclusion, this embodiment provides a method for obtaining a target account representation, so that the target account representation can effectively obtain information of a direct neighbor account entity and information of an indirect neighbor account entity in a knowledge graph, and can effectively capture high-order structured information of the knowledge graph. Furthermore, an interactive graph attention mechanism network is used, which can model the high-order structured information of the knowledge graph and commodity interaction information, so that the model can effectively capture a commodity cooperative signal, and a final recommendation result is more consistent with the intention. When learning a target account representation and a target commodity representation in a knowledge graph-based recommendation system, the importance of interactive learning is emphasized, so that the learned target account representation can perceive attribute features of a commodity, and the learned target commodity representation can perceive the interest and hobbies.

According to the method provided in this embodiment, attention analysis is performed through the interaction between a direct neighbor account embedding vector of a direct neighbor account entity and a target commodity embedding vector to obtain an attention score, so as to obtain an intermediate account neighbor representation based on the attention score, thereby emphasizing the importance of interactive learning. Thus, the learned target account representation can perceive the attribute features of the commodity, thereby improving the accuracy of the point of interest analysis, and avoiding the problem of data resource waste caused by a large number of repeated analyses.

According to the method provided in this embodiment, after a plurality of account attention scores are normalized, weighted combination is performed on the normalized attention scores, thereby balancing or fusing, by emphasis, the plurality of account attention scores and improving the analysis accuracy.

In the following embodiment, an exemplary method for calculating a target commodity representation is provided. Information from neighbor commodity entities is selectively aggregated through an interactive attention mechanism, and the target commodity representation is continuously updated through an iterative method, so that a target commodity entity can receive more comprehensive neighbor commodity information. Therefore, on a commodity side, each commodity entity n∈ [symbol] ^{u}[l] (the symbol in square brackets represents the number of iterations) selectively aggregates a direct commodity entity embedding vector {e_{n′}ⁱ[l−1]|n′∈ [symbol] (n)} ( [symbol] (n) represents a set of direct neighbor commodity entities of commodity entity n) from the commodity entity n under the supervision of a target account embedding vector eᵤ, to obtain [symbol] . After information propagation, a commodity embedding vector eₙⁱ[l−1] and a neighbor commodity embedding vector [symbol] are aggregated to obtain a value to be used in the next iteration.

FIG. 8 shows a schematic flow of calculating a target commodity representation according to an exemplary embodiment of this disclosure. The method may be performed by the terminal 120 or the server 140 or another computer device shown in FIG. 1. The method includes the following steps:

In step 801, under the supervision of a target account embedding vector, a neighbor commodity embedding vector corresponding to a b^{th} commodity entity is fused through a commodity relation embedding vector to obtain a b^{th} intermediate commodity neighbor representation.

The b^{th} commodity entity is any one commodity entity in a knowledge graph.

In this embodiment, the neighbor commodity embedding vector corresponding to the fused b^{th} commodity entity may be a whole neighbor commodity embedding vector or a partial neighbor commodity embedding vector.

In this embodiment, a target commodity embedding vector includes: a b^{th} commodity embedding vector, where b is a positive integer.

In an example, the b^{th} commodity entity includes k direct neighbor commodity entities, and the k direct neighbor commodity entities have a direct relation with the b^{th} commodity entity, where k is a natural number. This step includes the following sub-steps:

In sub-step 1, for the b^{th} commodity entity in the knowledge graph, a feature interaction is performed on the target account embedding vector and the k direct neighbor commodity embedding vectors through the commodity relation embedding vector, to obtain k commodity attention scores.

In an example, n is used to represent the direct neighbor commodity entity, i is used to represent the b^{th} commodity entity, u is used to represent a target account, r_{i,n} is configured to represent a relation between the a^{th} account entity and the direct neighbor account entity, and the commodity attention score is shown in equation (6):

$$γ ( {e}_{n} , {e}_{{r}_{i , n}} , {e}_{u} ) = {( {e}_{u} + {e}_{{r}_{i , n}} )}^{T} {e}_{n} \qquad Eq . ( 6 )$$

where eᵤ represents the target account embedding vector, eᵣ_{_{u,n}} represents the commodity relation embedding vector, and eₙ represents the direct neighbor commodity embedding vector.

In an example, the k commodity attention scores are normalized to obtain k normalized commodity attention scores.

Exemplarily, the normalized commodity attention score is shown in equation (7):

$$α ( {e}_{n} , {e}_{{r}_{i , n}} , {e}_{u} ) = \frac{exp ( γ ( {e}_{n} , {e}_{{r}_{i , n}} , {e}_{u} ) )}{{\sum }_{n ∈ 𝒩 ( i )} exp ( γ ( {e}_{n} , {e}_{{r}_{i , {n}^{′}}} , {e}_{u} ) )} \qquad Eq . ( 7 )$$

where γ(eₙ, eᵣ_{_{i,n}}, eᵤ) represents a non-normalized attention score, [symbol] (i)={n|(i, r_{i,n}, n)∈ [symbol] }, [symbol] (u) represents a set of the k direct neighbor commodity entities, [symbol] represents the knowledge graph, and exp( ) represents an exponential function based on a natural logarithm e.

In sub-step 2, a weighted combination is performed on the k commodity attention scores and the k direct neighbor commodity embedding vectors to obtain the b^{th} intermediate commodity neighbor representation.

The b^{th} intermediate commodity neighbor representation is used for representing an overall representation of the direct neighbor commodity entities of the b^{th} commodity entity.

In an example, weighted combination is performed on the k normalized commodity attention scores and the k direct neighbor commodity embedding vectors to obtain the b^{th} intermediate commodity neighbor representation.

Exemplarily, weighted combination is performed on the k normalized commodity attention scores and the k direct neighbor commodity embedding vectors to obtain the b^{th} intermediate commodity neighbor representation is shown in equation (8):

[symbol]

= [symbol] α(eₙ,eᵣ_{_{i,n}},eᵤ)eₙ Eq. (8)

where eₙ represents the direct neighbor account embedding vector, and α(eₙ, eᵣ_{_{i,n}}, eᵤ) is the normalized commodity attention score corresponding to eₙ.

In step 802, the b^{th} intermediate commodity neighbor representation and the commodity embedding vector of the b^{th} commodity entity are aggregated to obtain a b^{th} intermediate overall commodity representation.

The b^{th} intermediate overall commodity representation is used for representing a temporary commodity representation of the b^{th} commodity entity when the iterative process has not ended.

In an example, the b^{th} intermediate commodity neighbor representation and the b^{th} commodity embedding vector are fused to obtain the b^{th} intermediate overall commodity representation through an aggregator.

Exemplarily, the b^{th} intermediate overall commodity representation is shown in equation (9):

eᵢ= [symbol] =tanh(W(gᵢ⊙eᵢ+(1−gᵢ) [symbol] )+b) Eq. (9)

where agg( ) represents a gating aggregator, eᵢ represents the b^{th} commodity embedding vector, W and b in the formula are a weight parameter and a bias parameter respectively, [symbol] represents the b^{th} intermediate commodity neighbor representation, ⊙ represents an element-wise multiplication operation, gᵢ∈R^{d} is a gating vector, and d is a dimension of the embedding vector. Further, gᵢ=σ( [symbol] +b_{g}), where [;] represents a connection operation, W_{g}∈R^{d×d} and b_{g}∈R^{d} are used for calculating a weight and bias of the gating vector, and σ(⋅) represents a Sigmoid function.

In step 803, the b^{th} commodity embedding vector is updated through the b^{th} intermediate overall commodity representation.

In an example, the b^{th} commodity embedding vector is replaced with the b^{th} intermediate overall commodity representation.

In step 804, the foregoing three steps can be repeated for L₂ times, and then the b^{th} target commodity embedding vector can be determined as the target commodity representation.

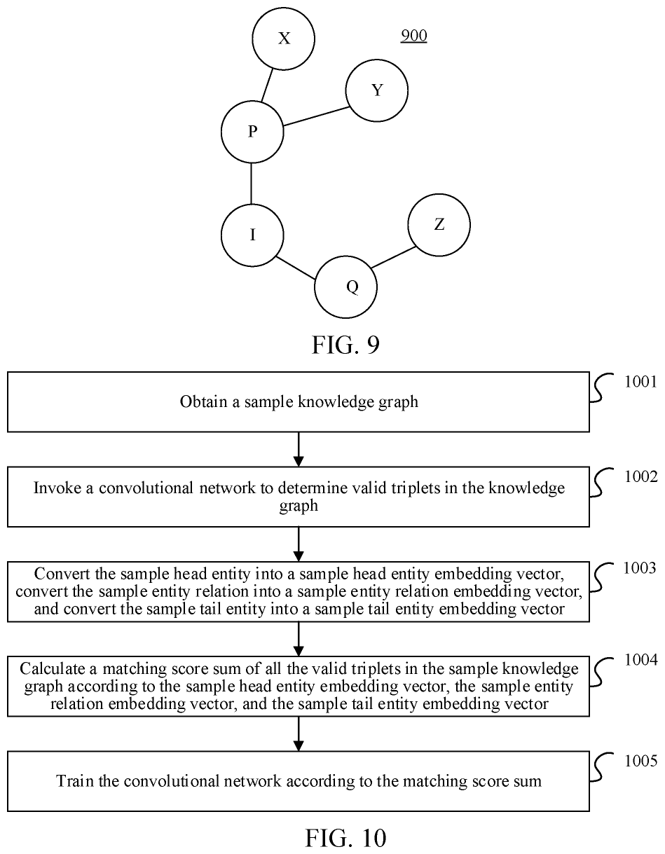

L₂ is an integer greater than or equal to a neighbor depth of the target commodity entity. Exemplarily, as shown in FIG. 9, in a knowledge graph 900, commodity entity I serves as the target commodity entity, commodity entity P and commodity entity Q are the direct neighbor commodity entities of commodity entity I, commodity entity X, commodity entity Y, and commodity entity E are the indirect neighbor commodity entities of commodity entity Z, and the neighbor depth is 2.

Exemplarily, as shown in FIG. 9, commodity entity I serves as the target commodity entity. It is first determined that the knowledge graph further includes commodity entity P, commodity entity Q, commodity entity X, commodity entity Y, and commodity entity Z.

Then in the first iteration, (1) the direct neighbor commodity entities of commodity entity I are commodity entity P and commodity entity Q, information aggregation is performed on commodity entity P and commodity entity Q, and the aggregated information is re-aggregated into commodity entity I. (2) The direct neighbor commodity entities of commodity entity P are commodity entity X and commodity entity Y, information aggregation is performed on commodity entity X and commodity entity Y, and the aggregated information is re-aggregated into commodity entity P. (3) Likewise, the direct neighbor commodity entity of commodity entity Q is commodity entity Z, and information of commodity entity Z is directly aggregated into commodity entity Q. Therefore, after the first iteration is completed, commodity entity I includes information of commodity entity I, information of commodity entity P, and information of commodity entity Q. Commodity entity P includes the information of commodity entity P, information of commodity entity X, and information of commodity entity Y. Commodity entity Q includes the information of commodity entity Q and information of commodity entity Z.

In the second iteration, information aggregation is mainly performed on commodity entity P and commodity entity Q, and the aggregated information is re-aggregated into commodity entity I. Since commodity entity P further includes the information of commodity entity X and commodity entity Y and commodity entity Q further includes the information of commodity entity Z after the first iteration is completed, the information of commodity entity X, the information of commodity entity Y, and the information of commodity entity Z are all transferred into commodity entity I after the second iteration is completed. Therefore, after the second iteration is completed, commodity entity I includes not only the information of commodity entity I, but also the information of commodity entity P, commodity entity Q, commodity entity X, commodity entity Y, and commodity entity Z.

In conclusion, this embodiment provides a method for obtaining a target commodity representation, so that the target commodity representation can effectively obtain information of a direct neighbor commodity entity and information of an indirect neighbor commodity entity in a knowledge graph, and can effectively capture high-order structured information of the knowledge graph. Furthermore, an interactive graph attention mechanism network is used, which can model the high-order structured information of the knowledge graph and commodity interaction information, so that the model can effectively capture a commodity cooperative signal, and a final recommendation result is more consistent with the intention. When learning a target account representation and a target commodity representation in a knowledge graph-based recommendation system, the importance of interactive learning is emphasized, so that the learned target account representation can perceive attribute features of a commodity, and the learned target commodity representation can perceive the interest and hobbies.

According to the method provided in this embodiment, attention analysis is performed through the interaction between a direct neighbor commodity embedding vector of a direct neighbor commodity entity and a target commodity embedding vector to obtain an attention score, so as to obtain an intermediate account neighbor representation based on the attention score, thereby emphasizing the importance of interactive learning. Thus, the learned target commodity representation can perceive the attribute features of the commodity, thereby improving the accuracy of the point of interest analysis, and avoiding the problem of data resource waste caused by a large number of repeated analyses.

According to the method provided in this embodiment, after a plurality of commodity attention scores are normalized, weighted combination is performed on the normalized attention scores, thereby balancing or fusing, by emphasis, the plurality of commodity attention scores and improving the analysis accuracy.

In order to obtain an entity embedding vector and an entity relation embedding vector through a convolutional network, the convolutional network needs to be trained to obtain a more accurate entity embedding vector and entity relation embedding vector. A convolutional network ConvE model is exemplified in the embodiments of this disclosure.

FIG. 10 shows a schematic flowchart of a pre-training convolutional network method according to an exemplary embodiment of this disclosure. The method may be performed by the terminal 120 or the server 140 or another computer device shown in FIG. 1. The method includes the following steps:

In step 1001, a sample knowledge graph is obtained.

The sample knowledge graph is a knowledge graph used as a training sample.

In step 1002, a convolutional network can be invoked (or applied) to determine valid triplets in the knowledge graph.

In the knowledge graph, the valid triplet includes a sample head entity, a sample entity relation, and a sample tail entity. The valid triplet is represented as (h, r, t), for representing that there is a sample entity relation r between a sample head entity h and a sample tail entity t.

In step 1003, the sample head entity is converted into a sample head entity embedding vector, the sample entity relation is converted into a sample entity relation embedding vector, and the sample tail entity is converted into a sample tail entity embedding vector.

In step 1004, a matching score sum of all the valid triplets in the sample knowledge graph can be calculated according to the sample head entity embedding vector, the sample entity relation embedding vector, and the sample tail entity embedding vector.

In an example, the method for calculating matching scores is shown in equation (10) as follows:

$$ψ ( h , r , t ) = {( ReLU ( ve c ( R e L U ( [ \overline{{e}_{h}} ; \overline{{e}_{r}} ] * ω ) ) W ) )}^{T} {e}_{t} \qquad Eq . ( 10 )$$

where eₕ∈R^{d}, eᵣ∈R^{d}, and eₜ∈R^{d} are a head entity embedding vector, an entity relation embedding vector, and a tail entity embedding vector, respectively, d is an embedding vector dimension, e̅ₕ̅∈R^{d}^{₁}^{×d}^{₂} and e̅ᵣ̅∈R^{d}^{₁}^{×d}^{₂} represent two-dimensional reshaping of eₕ and eᵣ, and d=d₁×d₂. ω represents a convolution kernel, a matrix vec operator (vec) represents a matrix straightening operation, W is a conversion matrix, and a rectified linear unit (ReLU) represents a linear rectification function.

In step 1005, the convolutional network can be trained according to the matching score sum.

In an example, the convolutional network is trained according to an error back propagation algorithm.

In an example, when the matching score sum converges, the convolutional network training is completed.

In conclusion, this embodiment provides a pre-training method for a convolutional network, which can effectively obtain the convolutional network, make an embedding vector obtained more accurate, and improve computational efficiency.

According to the method provided in this embodiment, the convolutional network is trained in the form of sample triplets, thereby improving the training efficiency of the convolutional network and improving the prediction accuracy of an embedding vector.

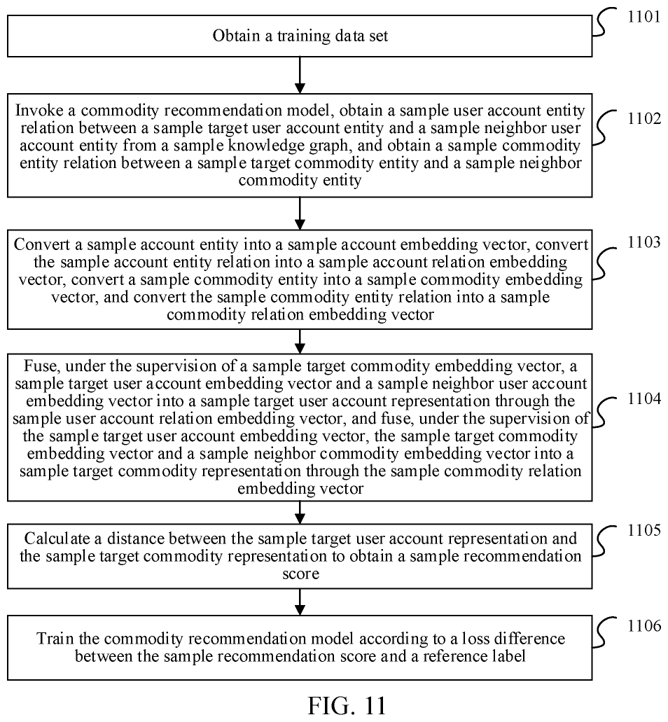

FIG. 11 shows a schematic flowchart of a trained commodity recommendation model method according to an exemplary embodiment of this disclosure. The method may be performed by the terminal 120 or the server 140 or another computer device shown in FIG. 1. The method includes the following steps:

In step 1101, a training data set is obtained.

The training data set includes a sample knowledge graph and a reference label corresponding to the sample knowledge graph. If there is a historical interaction record between a user account entity and a commodity entity, a value of the reference label is 1. If there is no historical interaction record between the user account entity and the commodity entity, the value of the reference label is 0.

In an example, the reference label in this embodiment is a true label determined according to the historical interaction record, namely a label of the interaction actually occurring according to the true historical interaction record.

In step 1102, based on a commodity recommendation model. A sample user account entity relation between a sample target user account entity and a sample neighbor user account entity can be obtained from the sample knowledge graph, and a sample commodity entity relation between a sample target commodity entity and a sample neighbor commodity entity can be obtained.

The sample knowledge graph includes sample user account entities and sample commodity entities. The sample user account entities include a sample target user account entity and a sample neighbor user account entity. The sample target user account entity is any one user account entity in the sample user account entities, and the sample neighbor user account entity is a direct neighbor entity or an indirect neighbor entity of the sample target user account entity. Accordingly, the sample commodity entities include a sample target commodity entity and a sample neighbor commodity entity. The sample target commodity entity is any one commodity entity in the sample commodity entities, and the sample neighbor commodity entity is a direct neighbor entity or an indirect neighbor entity of the sample target commodity entity.

In an example, there is a sample user account-commodity relation between the sample user account entity and the sample commodity entity.

In step 1103, a sample account entity is converted into a sample account embedding vector, the sample account entity relation is converted into a sample account relation embedding vector, a sample commodity entity is converted into a sample commodity embedding vector, and the sample commodity entity relation is converted into a sample commodity relation embedding vector.

In an example, in this embodiment of this disclosure, a convolutional network is invoked to convert, through a vector searching operation, the sample user account entity and the sample user account entity relation into the sample user account embedding vector and the sample user account relation embedding vector and to convert the sample commodity entity and the sample commodity entity relation into the sample commodity embedding vector and the sample commodity relation embedding vector. The vector searching operation is used for searching for the corresponding embedding vectors according to the entities and/or the entity relations.

In an example, the structure of the convolutional network includes at least one of a ConvE model, a ConvKB model, an R-GCN model, or a ConvR model. The specific structure of the convolutional network is not limited in this disclosure.

In step 1104, under the supervision of a sample target commodity embedding vector, a sample target user account embedding vector and a sample neighbor user account embedding vector are fused into a sample target user account representation through the sample user account relation embedding vector. Under the supervision of the sample target user account embedding vector, the sample target commodity embedding vector and a sample neighbor commodity embedding vector are fused into a sample target commodity representation through the sample commodity relation embedding vector.

The sample target user account representation includes features of the sample target user account and features of the sample neighbor user account.

The sample target commodity representation includes features of the sample target commodity and features of the sample neighbor commodity.

In an example, in an iterative manner, the sample target user account representation and the sample target commodity representation are obtained through attention information propagation and information aggregation. Since information from the sample indirect neighbor user account entity and the sample indirect neighbor commodity entity are respectively aggregated in the iterative process, the sample target user account representation and the sample target commodity representation include high-order structured information in the sample knowledge graph.

In step 1105, a distance between the sample target user account representation and the sample target commodity representation can be calculated to obtain a sample recommendation score.

The sample recommendation score is used for representing a degree of matching between a sample target user account and a sample target commodity.

In an example, the distance between the sample target user account representation and the sample target commodity representation is calculated through a dot product operation.

In an example, the sample recommendation score falls within an interval (0, 1).

In an example, cosine similarity of the sample target user account representation and the sample target commodity representation is calculated to obtain the sample recommendation score.

In step 1106, the commodity recommendation model can be trained according to a loss difference between the sample recommendation score and the reference label.

In an example, a loss function is invoked, the loss difference between the sample recommendation score and the reference label is calculated, and the commodity recommendation model is trained according to the loss difference.

Exemplarily, the loss function is show in equation (11) as follows:

[symbol]

=− [symbol] +log ŷᵤ_{ᵢ}− [symbol] −log(1−ŷᵤ_{ⱼ}) Eq. (11)

where [symbol] ⁺={(u, i)|ŷᵤᵢ=1} and [symbol] ⁻={(u, j)|ŷᵤⱼ=1} are a positive sample pair and a negative sample pair respectively, u represents a target user account entity, i represents a commodity entity in the positive sample pair, and j represents a commodity entity in the negative sample pair. log represents a logarithm operation, ŷᵤ_{ᵢ} represents the sample recommendation score of commodity entity i, and ŷᵤ_{ⱼ} represents the sample recommendation score of commodity entity j.

In conclusion, this embodiment provides a training method for a commodity recommendation model, which can quickly and effectively obtain the commodity recommendation model, shorten the training time of the commodity recommendation model, and improve the training efficiency.

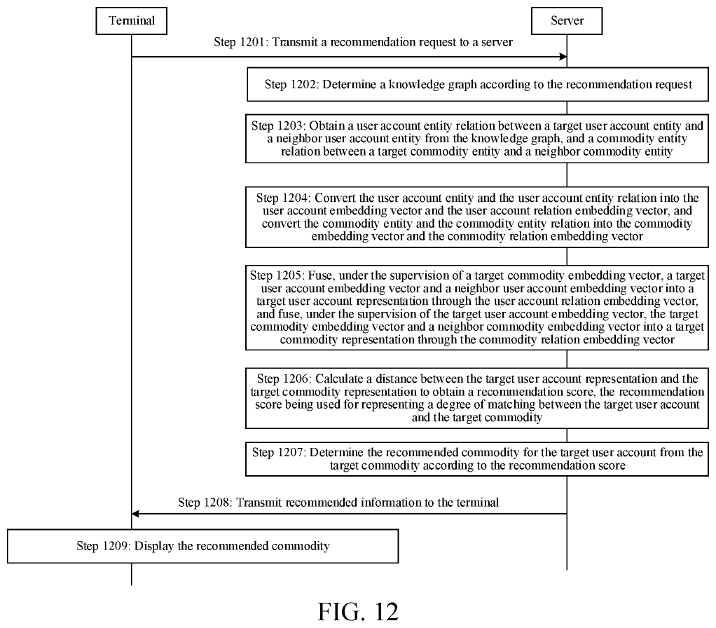

FIG. 12 shows a schematic flowchart of an exemplary knowledge graph-based information recommendation method according to an exemplary embodiment of this disclosure. The method may be performed by the computer system shown in FIG. 1. The method includes the following steps:

In step 1201, a terminal transmits a recommendation request to a server.

The recommendation request is used for requesting the server to return a recommended commodity for a target user account.

In some embodiments, when starting a commodity browsing interface, the terminal transmits the recommendation request to the server; or when refreshing the commodity browsing interface, the terminal transmits the recommendation request to the server; or the terminal periodically transmits the recommendation request to the server. This is not limited in this embodiment.

In step 1202, the server determines a knowledge graph according to the recommendation request.

In an example, the recommendation request includes the target user account. The server determines the knowledge graph according to the target user account included in the recommendation request. The knowledge graph obtained by determining includes a target user account entity corresponding to the target user account.

In step 1203, the server obtains a user account entity relation between a target user account entity and a neighbor user account entity from the knowledge graph, and a commodity entity relation between a target commodity entity and a neighbor commodity entity.

The target user account entity in this embodiment specifically refers to a user account corresponding to the terminal that transmits the recommendation request.

The target commodity entity may be one or more commodities.

The knowledge graph includes user account entities and commodity entities. The user account entities include a target user account entity and a neighbor user account entity. The target user account entity is any one user account entity in the user account entities, and the neighbor user account entity is a direct neighbor entity or an indirect neighbor entity of the target user account entity. Accordingly, the commodity entities include a target commodity entity and a neighbor commodity entity. The target commodity entity is any one commodity entity in the commodity entities, and the neighbor commodity entity is a direct neighbor entity or an indirect neighbor entity of the target commodity entity.

In an example, there is a user account-commodity relation between the user account entity and the commodity entity.

In step 1204, the server converts the user account entity and the user account entity relation into the user account embedding vector and the user account relation embedding vector and converts the commodity entity and the commodity entity relation into the commodity embedding vector and the commodity relation embedding vector.

The user account embedding vector is an embedding vector corresponding to the user account entity. The user account relation embedding vector is an embedding vector corresponding to the user account entity relation.

The commodity embedding vector is an embedding vector corresponding to the commodity entity. The commodity relation embedding vector is an embedding vector corresponding to the commodity entity relation.

In an example, in this embodiment of this disclosure, a convolutional network is invoked to convert, through a vector searching operation, the user account entity and the user account entity relation into the user account embedding vector and the user account relation embedding vector and to convert the commodity entity and the commodity entity relation into the commodity embedding vector and the commodity relation embedding vector. The vector searching operation is used for searching for the corresponding embedding vectors according to the entities and/or the entity relations.

In step 1205, the server fuses, under the supervision of a target commodity embedding vector, a target user account embedding vector and a neighbor user account embedding vector into a target user account representation through the user account relation embedding vector, and the server fuses, under the supervision of the target user account embedding vector, the target commodity embedding vector and a neighbor commodity embedding vector into a target commodity representation through the commodity relation embedding vector.

The target user account representation includes features of the target user account and features of the neighbor user account.

The target commodity representation includes features of the target commodity and features of the neighbor commodity.

In an example, in an iterative manner, the target user account representation and the target commodity representation are obtained through attention information propagation and information aggregation. Since information from the indirect neighbor user account entity and the indirect neighbor commodity entity is aggregated in the iterative process, the target user account representation and the target commodity representation include high-order structured information in the knowledge graph.

In step 1206, the server calculates a distance between the target user account representation and the target commodity representation to obtain a recommendation score.

In an example, the distance between the target user account representation and the target commodity representation is calculated through a dot product operation.

In an example, cosine similarity of the target user account representation and the target commodity representation is calculated to obtain the recommendation score.

In step 1207, the server determines the recommended commodity for the target user account from the target commodity according to the recommendation score.

In an example, a target commodity having the recommendation score greater than a score threshold is determined as the recommended commodity for the target user account from the target commodity. Exemplarily, the score threshold is set as 0.5, and a commodity having the recommendation score greater than 0.5 is determined as the recommended commodity from the target commodity.

In an example, the recommended commodity for the target user account is determined from the target commodity according to an arrangement order of the recommendation score.

In step 1208, the server transmits recommended information to the terminal.

The recommended information includes information of the recommended commodity. In an example, the recommended information further includes information of the target user account.

In step 1209, the terminal displays the recommended commodity.

In conclusion, in this embodiment, when learning a target user account representation and a target commodity representation in a knowledge graph-based recommendation system, the importance of interactive learning is emphasized, so that the learned target user account representation can perceive attribute features of a commodity, and the learned target commodity representation can perceive the interest and hobbies of users. Furthermore, an interactive graph attention mechanism network is used, which can explicitly model the high-order structured information of the knowledge graph and user commodity interaction information, so that the model can effectively capture a user commodity cooperative signal, and a system recommendation result is more consistent with the intention of users.

In a typical application scenario, such as advertisement recommendation, in this embodiment, a user commodity unified knowledge graph can be constructed according to a plurality of user behaviors of platform traffic, such as click/tap and conversion of data, and user portrait and commodity portrait data, so as to recommend commodity advertisements more relevant to the intention of users, thereby effectively improving the click/tap conversion rate of commodity advertisements and improving the user experience.

The following describes apparatus embodiments of this disclosure. For details which are not described in detail in the apparatus embodiments, reference may be made to the corresponding description of the foregoing method embodiments. The details will not be repeated herein.

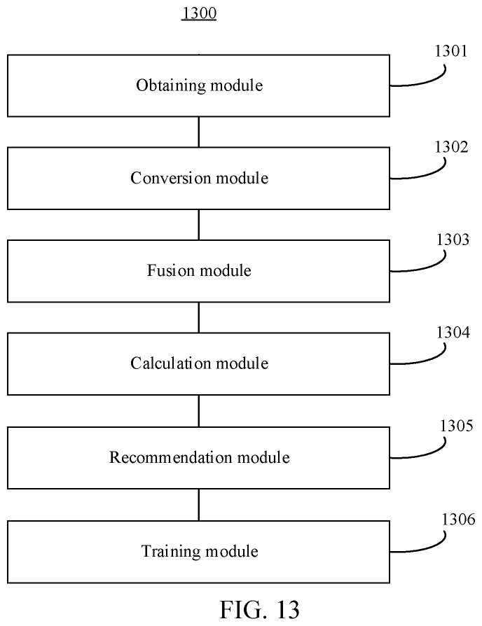

FIG. 13 shows a schematic structural diagram of a knowledge graph-based information recommendation apparatus according to an exemplary embodiment of this disclosure. The apparatus may be implemented in software, hardware or a combination of both as all or part of a computer device. The apparatus 1300 includes an obtaining module 1301, a conversion module 1302, a fusion module 1303, a calculation module 1304, and a recommendation module 1305. One or more modules, submodules, and/or units of the apparatus can be implemented by processing circuitry, software, or a combination thereof, for example.

The obtaining module 1301 is configured to obtain an account entity relation between a target account entity and a neighbor account entity from a knowledge graph, and obtain a commodity entity relation between a target commodity entity and a neighbor commodity entity.

The conversion module 1302 is configured to convert an account entity into an account embedding vector, convert the account entity relation into an account relation embedding vector, convert a commodity entity into a commodity embedding vector, and convert the commodity entity relation into a commodity relation embedding vector.

The fusion module 1303 is configured to fuse, under the supervision of a target commodity embedding vector, a target account embedding vector of the target account entity and a neighbor account embedding vector through the account relation embedding vector to obtain a target account representation, and fuse, under the supervision of the target account embedding vector, the target commodity embedding vector of the target commodity entity and a neighbor commodity embedding vector through the commodity relation embedding vector to obtain a target commodity representation.

The calculation module 1304 is configured to calculate a distance between the target account representation and the target commodity representation, the distance being used for representing a degree of matching between a target account and a target commodity.

The recommendation module 1305 is configured to determine, based on the distance between the target account representation and the target commodity representation, a commodity recommended for the target account from the target commodity.

In an exemplary design of this disclosure, the target account embedding vector includes: an account embedding vector of an a^{th} account entity, a being a positive integer. The fusion module 1303 is further configured to: fuse, under the supervision of the target commodity embedding vector, a neighbor account embedding vector corresponding to the a^{th} account entity through the account relation embedding vector to obtain an a^{th} intermediate account neighbor representation; fuse the a^{th} intermediate account neighbor representation and the account embedding vector of the a^{th} account entity to obtain an a^{th} intermediate overall account representation; update the a^{th} account embedding vector through the a^{th} intermediate overall account representation; and repeat the foregoing three steps for L₁ times, and then determine the a^{th} account embedding vector as the target account representation, L₁ being an integer greater than or equal to a neighbor depth of the target account entity.

In an exemplary design of this disclosure, the a^{th} account entity includes j direct neighbor account entities, the j direct neighbor account entities having a direct relation with the a^{th} account entity. The fusion module 1303 is further configured to: perform feature interaction on the target commodity embedding vector and j direct neighbor account embedding vectors through the account relation embedding vector, to obtain j account attention scores, j being a positive integer; and perform weighted combination on the j account attention scores and the j direct neighbor account embedding vectors to obtain the a^{th} intermediate account neighbor representation.

In an exemplary design of this disclosure, the fusion module 1303 is further configured to: normalize the j account attention scores to obtain j normalized account attention scores; and perform weighted combination on the j normalized account attention scores and the j direct neighbor account embedding vectors to obtain the a^{th} intermediate account neighbor representation.

In an exemplary design of this disclosure, the target commodity embedding vector includes: a commodity embedding vector of a b^{th} commodity entity, b being a positive integer. The fusion module 1303 is further configured to: fuse, under the supervision of the target account embedding vector, a neighbor commodity embedding vector corresponding to the b^{th} commodity entity through the commodity relation embedding vector to obtain a b^{th} intermediate commodity neighbor representation; aggregate the b^{th} intermediate commodity neighbor representation and the commodity embedding vector of the b^{th} commodity entity to obtain a b^{th} intermediate overall commodity representation; update the b^{th} commodity embedding vector through the b^{th} intermediate overall commodity representation; and repeat the foregoing three steps for L₂ times, and then determine the b^{th} target commodity embedding vector as the target commodity representation, L₂ being an integer greater than or equal to a neighbor depth of the target commodity entity.

In an exemplary design of this disclosure, the b^{th} commodity entity includes k direct neighbor commodity entities, the k direct neighbor commodity entities having a direct relation with the b^{th} commodity entity. The fusion module 1303 is further configured to: perform feature interaction on the target account embedding vector and k direct neighbor commodity embedding vectors through the commodity relation embedding vector, to obtain k commodity attention scores, k being a positive integer; and perform weighted combination on the k commodity attention scores and the k direct neighbor commodity embedding vectors to obtain the b^{th} intermediate commodity neighbor representation.

In an exemplary design of this disclosure, the fusion module 1303 is further configured to: normalize the k commodity attention scores to obtain k normalized commodity attention scores; and perform weighted combination on the k normalized commodity attention scores and the k direct neighbor commodity embedding vectors to obtain the b^{th} intermediate commodity neighbor representation.

In an exemplary design of this disclosure, the conversion module 1302 is further configured to: invoke a convolutional network, convert, through a vector searching operation, the account entity into the account embedding vector, and convert the account entity relation into the account relation embedding vector; and convert the commodity entity into the commodity embedding vector, and convert the commodity entity relation into the commodity relation embedding vector.

In an exemplary design of this disclosure, the apparatus further includes a training module 1306.

The training module 1306 is configured to: obtain a sample knowledge graph; invoke the convolutional network to determine valid triplets in the sample knowledge graph, the valid triplet including a sample head entity, a sample entity relation, and a sample tail entity; convert the sample head entity into a sample head entity embedding vector, convert the sample entity relation into a sample entity relation embedding vector, and convert the sample tail entity into a sample tail entity embedding vector; calculate a matching score sum of all the valid triplets in the sample knowledge graph according to the sample head entity embedding vector, the sample entity relation embedding vector, and the sample tail entity embedding vector; and train the convolutional network according to the matching score sum.

In an exemplary design of this disclosure, the recommendation module 1305 is further configured to: determine, from the target commodity, a commodity having the recommendation score greater than a score threshold as the commodity recommended for the target account; or, determine the commodity recommended for the target account from the target commodity according to an arrangement order of the recommendation score.

In an exemplary design of this disclosure, the training module 1306 is further configured to: obtain a training data set, the training data set including a sample knowledge graph and a reference label corresponding to the sample knowledge graph; invoke a commodity recommendation model, obtain a sample account entity relation between a sample target account entity and a sample neighbor account entity from the sample knowledge graph, and obtain a sample commodity entity relation between a sample target commodity entity and a sample neighbor commodity entity; convert a sample account entity into a sample account embedding vector, and convert the sample account entity relation into a sample account relation embedding vector; convert a sample commodity entity into a sample commodity embedding vector, and convert the sample commodity entity relation into a sample commodity relation embedding vector; fuse, under the supervision of a sample target commodity embedding vector, a sample target account embedding vector and a sample neighbor account embedding vector into a sample target account representation through the sample account relation embedding vector; fuse, under the supervision of the sample target account embedding vector, the sample target commodity embedding vector and a sample neighbor commodity embedding vector into a sample target commodity representation through the sample commodity relation embedding vector; calculate a distance between the sample target account representation and the sample target commodity representation to obtain a sample recommendation score, the sample recommendation score being used for representing a degree of matching between a sample target account and a sample target commodity; and train the commodity recommendation model according to a loss difference between the sample recommendation score and the reference label.

In conclusion, in this embodiment, a target user account representation is obtained through a target user account embedding vector and a neighbor user account embedding vector, and a target commodity representation is obtained through a target commodity embedding vector and a neighbor commodity embedding vector. The target user account representation obtained thereby includes both features of a target user account and features of a neighbor user account. Likewise, the target commodity representation includes both the features of the target commodity and the features of the neighbor commodity. Therefore, the target user account representation and the target commodity representation are more expressive, and can better express the features of the target user account and the target commodity, so that the accuracy of a recommendation result thus obtained is better.

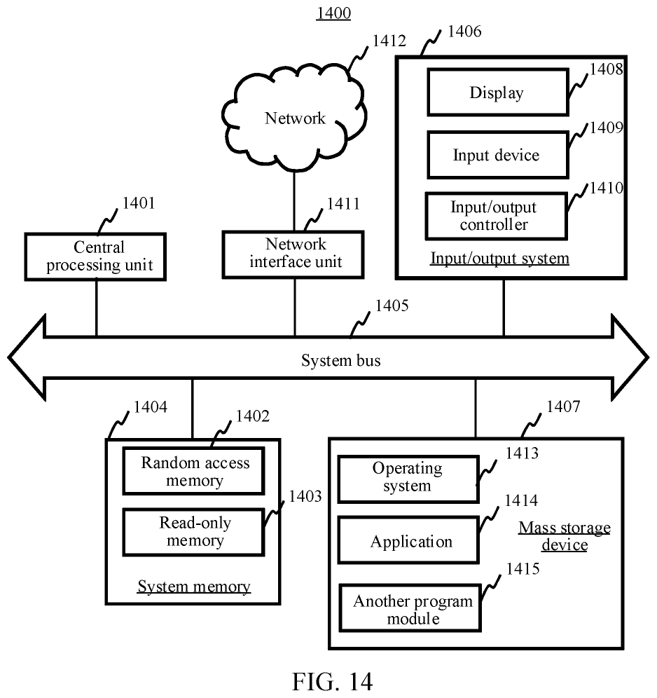

FIG. 14 is a schematic structural diagram of a computer device according to an exemplary embodiment. The computer device 1400 includes processing circuitry, such as a central processing unit (CPU) 1401, a system memory 1404 including a random access memory (RAM) 1402 and a read-only memory (ROM) 1403, and a system bus 1405 connecting the system memory 1404 and the central processing unit 1401. The computer device 1400 further includes a basic input/output (I/O) system 1406 that facilitates transfer of information between elements within the computer device, and a mass storage device 1407 that stores an operating system 1413, an application 1414, and another program module 1415.

The basic input/output system 1406 includes a display 1408 for displaying information and an input device 1409 such as a mouse or a keyboard for inputting information by a user. The display 1408 and the input device 1409 are connected to the central processing unit 1401 through an input output controller 1410 which is connected to the system bus 1405. The basic input/output system 1406 may further include the input output controller 1410 for receiving and processing input from a plurality of other devices, such as a keyboard, a mouse, or an electronic stylus. Similarly, the input output controller 1410 also provides output to a display screen, a printer, or another type of output device.

The mass storage device 1407 is connected to the central processing unit 1401 through a mass storage controller (not shown) connected to the system bus 1405. The mass storage device 1407 and a computer device-readable medium associated therewith provide non-volatile storage for the computer device 1400. That is, the mass storage device 1407 may include a computer device-readable medium (not shown) such as a hard disk or a compact disc read-only memory (CD-ROM) drive.

The foregoing system memory 1404 and mass storage device 1407 may be collectively referred to as a memory.

According to various embodiments of the present disclosure, the computer device 1400 may also operate through a remote computer device connected to a network through, for example, the Internet. That is, the computer device 1400 may be connected to a network 1411 through a network interface unit 1412 which is connected to the system bus 1405, or may be connected to another type of network or remote computer device system (not shown) by using the network interface unit 1412.

The memory further includes one or more programs. The one or more programs are stored in the memory. The central processing unit 1401 implements all or part of the steps of the foregoing knowledge graph-based information recommendation method by executing the one or more programs.

In an exemplary embodiment, a computer-readable storage medium, such as a non-transitory computer-readable storage medium, is also provided. The computer-readable storage medium stores at least one instruction, at least one program, a code set, or an instruction set. The at least one instruction, the at least one program, the code set, or the instruction set is loaded and executed by a processor to implement the knowledge graph-based information recommendation method provided in the foregoing various method embodiments.

This disclosure also provides a computer-readable storage medium. The storage medium stores at least one instruction, at least one program, a code set, or an instruction set. The at least one instruction, the at least one program, the code set, or the instruction set is loaded and executed by a processor to implement the knowledge graph-based information recommendation method provided in the foregoing method embodiments.

In an embodiment, this disclosure also provides a computer program product including instructions that, when run on a computer device, enable the computer device to perform the knowledge graph-based information recommendation method in the foregoing various aspects.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

What is claimed is:

1. A method of knowledge graph-based information recommendation, the method comprising:
obtaining an account entity relation between a target account entity and a neighbor account entity of the target account entity from a knowledge graph, and an item entity relation between a target item entity and a neighbor item entity of the target item entity, the target account entity and the neighbor account entity being included in a plurality of account entities, the target item entity and the neighbor item entity being included in a plurality of item entities;
converting the plurality of account entities into a plurality of account embedding vectors, the account entity relation into an account relation embedding vector, the plurality of item entities into a plurality of item embedding vectors, and the item entity relation into an item relation embedding vector;
based on a target item embedding vector of the plurality of item embedding vectors associated with the target item entity, fusing a target account embedding vector of the plurality of account embedding vectors associated with the target account entity and a neighbor account embedding vector of the plurality of account embedding vectors associated with the neighbor account entity through the account relation embedding vector to obtain a target account representation;
based on the target account embedding vector of the plurality of account embedding vectors associated with the target account entity, fusing the target item embedding vector of the plurality of item embedding vectors associated with the target item entity and a neighbor item embedding vector of the plurality of item embedding vectors associated with the neighbor item entity through the item relation embedding vector to obtain a target item representation; and
based on a distance between the target account representation and the target item representation, determining a target item for a target account of the target account entity from the target item entity, the distance indicating a degree of matching between the target account and the determined target item.

2. The method according to claim 1, wherein
the target account embedding vector includes an a^{th} account embedding vector associated with an a^{th} account of the target account entity, a being a positive integer; and
the fusing the target account embedding vector further comprises:
based on the target item embedding vector, fusing a neighbor account embedding vector of a neighbor account corresponding to the a^{th} account through the account relation embedding vector to obtain an a^{th} intermediate account neighbor representation;
fusing the a^{th} intermediate account neighbor representation and the a^{th} account embedding vector of the a^{th} account to obtain an a^{th} intermediate overall account representation;
updating the a^{th} account embedding vector based on the a^{th} intermediate overall account representation; and
determining the updated a^{th} account embedding vector as the target account representation.

3. The method according to claim 2, wherein
the a^{th} account includes j direct neighbor accounts, each of the j direct neighbor accounts having a direct relation with the a^{th} account; and
the fusing the neighbor account embedding vector further comprises:
performing a feature interaction on the target item embedding vector and j direct neighbor account embedding vectors associated with the j direct neighbor accounts through the account relation embedding vector to obtain j account attention scores, j being a positive integer; and
performing a weighted combination on the j account attention scores and the j direct neighbor account embedding vectors to obtain the a^{th} intermediate account neighbor representation.

4. The method according to claim 3, wherein the performing the weighted combination comprises:
normalizing the j account attention scores to obtain j normalized account attention scores; and
performing a weighted combination on the j normalized account attention scores and the j direct neighbor account embedding vectors to obtain the a^{th} intermediate account neighbor representation.

5. The method according to claim 1, wherein
the target item embedding vector includes a b^{th} item embedding vector of a b^{th} item, b being a positive integer; and
the fusing the target item embedding vector further comprises:
based on the target account embedding vector, fusing a neighbor item embedding vector of a neighbor item corresponding to the b^{th} item through the item relation embedding vector to obtain a b^{th} intermediate item neighbor representation;
aggregating the b^{th} intermediate item neighbor representation and the b^{th} item embedding vector of the b^{th} item entity to obtain a b^{th} intermediate overall item representation;
updating the b^{th} item embedding vector based on the b^{th} intermediate overall item representation; and
determining the b^{th} target item embedding vector as the target item representation.

6. The method according to claim 5, wherein
the b^{th} item includes k direct neighbor items, each of the k direct neighbor items having a direct relation with the b^{th} item; and
the fusing the neighbor item embedding vector further comprises:
performing a feature interaction on the target account embedding vector and k direct neighbor item embedding vectors associated with the k direct neighbor items through the item relation embedding vector to obtain k item attention scores, k being a positive integer; and
performing a weighted combination on the k item attention scores and the k direct neighbor item embedding vectors to obtain the b^{th} intermediate item neighbor representation.

7. The method according to claim 6, wherein the performing the weighted combination comprises:
normalizing the k item attention scores to obtain k normalized item attention scores; and
performing a weighted combination on the k normalized item attention scores and the k direct neighbor item embedding vectors to obtain the b^{th} intermediate item neighbor representation.

8. The method according to claim 1, wherein the converting further comprises:
based on a convolutional network, converting the plurality of account entities into the plurality of account embedding vectors, the account entity relation into the account relation embedding vector, the plurality of item entities into the plurality of item embedding vectors, and the item entity relation into the item relation embedding vector through a vector search operation.

9. The method according to claim 8, further comprising:
obtaining a sample knowledge graph;
based on the convolutional network, determining a plurality of valid triplets in the sample knowledge graph, each of the plurality of valid triplets including a sample head entity, a sample entity relation, and a sample tail entity;
converting each of the sample head entities into a sample head entity embedding vector, each of the sample entity relation into a sample entity relation embedding vector, and each of the sample tail entities into a sample tail entity embedding vector;
calculating a sum of matching scores of the plurality of valid triplets in the sample knowledge graph according to the sample head entity embedding vectors, the sample entity relation embedding vectors, and the sample tail entity embedding vectors; and
training the convolutional network according to the sum of the matching scores.

10. The method according to claim 1, wherein the determining the target item for the target account further comprises:
obtaining a plurality of recommendation scores based on the distance between the target account representation and the target item representation, each of the plurality of recommendation scores indicating a degree of matching between the target account and a respective target item of the target item entity; and
determining the target item for the target account of the target account entity from the target item entity according to the plurality of recommendation scores.

11. The method according to claim 10, wherein the determining the target item for the target account of the target account entity from the target item entity according to the recommendation score comprises:
determining the target item for the target account from the target item entity based on one of (i) a corresponding recommendation score being greater than a score threshold and (ii) an arrangement order of the plurality of recommendation scores.

12. The method according to claim 1, further comprising:
obtaining a training data set, the training data set including a sample knowledge graph and a reference label corresponding to the sample knowledge graph;
based on an item recommendation model, obtaining a sample account entity relation between a sample target account entity and a sample neighbor account entity of the sample target account entity from the sample knowledge graph, and a sample item entity relation between a sample target item entity and a sample neighbor item entity of the sample target item entity, the sample target account entity and the sample neighbor account entity being included in a plurality of sample account entities, the sample target item entity and the sample neighbor item entity being included in a plurality of sample item entities;
converting the plurality of sample account entities into a plurality of sample account embedding vectors, the sample account entity relation into a sample account relation embedding vector, the plurality of sample item entities into a plurality of sample item embedding vectors, and the sample item entity relation into a sample item relation embedding vector;
based on a sample target item embedding vector of the plurality of sample item embedding vectors associated with the sample target item entity, fusing a sample target account embedding vector of the plurality of sample account embedding vectors associated with the sample target account entity and a sample neighbor account embedding vector of the plurality of sample account embedding vectors associated with the sample neighbor account entity into a sample target account representation through the sample account relation embedding vector;
based on the sample target account embedding vector of the plurality of sample account embedding vectors associated with the sample target account entity, fusing the sample target item embedding vector the plurality of sample item embedding vectors associated with the sample target item entity and a sample neighbor item embedding vector of the plurality of sample item embedding vectors associated with the sample neighbor item entity into a sample target item representation through the sample item relation embedding vector;
determining a distance between the sample target account representation and the sample target item representation to obtain a sample recommendation score, the sample recommendation score indicating a degree of matching between a sample target account of the sample target account entity and a sample target item of the sample target item entity; and
training the item recommendation model according to a loss difference between the sample recommendation score and the reference label.

13. The method according to claim 1, wherein:
the target item entity includes one of a target product and a target service,
the neighbor item entity includes one of a neighbor product of the target product and a neighbor service of the target service, and
each of the plurality of item entities includes one of a respective product and a respective service.

14. An apparatus of knowledge graph-based information recommendation, the apparatus comprising:
processing circuitry configured to:
obtain an account entity relation between a target account entity and a neighbor account entity of the target account entity from a knowledge graph, and an item entity relation between a target item entity and a neighbor item entity of the target item entity, the target account entity and the neighbor account entity being included in a plurality of account entities, the target item entity and the neighbor item entity being included in a plurality of item entities;
convert the plurality of account entities into a plurality of account embedding vectors, the account entity relation into an account relation embedding vector, the plurality of item entities into a plurality of item embedding vectors, and the item entity relation into an item relation embedding vector;
based on a target item embedding vector of the plurality of item embedding vectors associated with the target item entity, fuse a target account embedding vector of the plurality of account embedding vectors associated with the target account entity and a neighbor account embedding vector of the plurality of account embedding vectors associated with the neighbor account entity through the account relation embedding vector to obtain a target account representation;
based on the target account embedding vector of the plurality of account embedding vectors associated with the target account entity, fuse the target item embedding vector of the plurality of item embedding vectors associated with the target item entity and a neighbor item embedding vector of the plurality of item embedding vectors associated with the neighbor item entity through the item relation embedding vector to obtain a target item representation; and
based on a distance between the target account representation and the target item representation, determine a target item for a target account of the target account entity from the target item entity, the distance indicating a degree of matching between the target account and the determined target item.

15. The apparatus according to claim 14, wherein the target account embedding vector comprises: an a^{th} account embedding vector associated with an a^{th} account of the target account entity, a being a positive integer; and
the processing circuitry is further configured to:
based on the target item embedding vector, fuse a neighbor account embedding vector of a neighbor account corresponding to the a^{th} account through the account relation embedding vector to obtain an a^{th} intermediate account neighbor representation;
fuse the a^{th} intermediate account neighbor representation and the a^{th} account embedding vector of the a^{th} account to obtain an a^{th} intermediate overall account representation;
update the a^{th} account embedding vector based on the a^{th} intermediate overall account representation; and
determine the updated a^{th} account embedding vector as the target account representation.

16. The apparatus according to claim 15, wherein the a^{th} account includes j direct neighbor accounts, each of the j direct neighbor accounts having a direct relation with the a^{th} account; and
the processing circuitry is further configured to:
perform a feature interaction on the target item embedding vector and j direct neighbor account embedding vectors associated with the j direct neighbor accounts through the account relation embedding vector to obtain j account attention scores, j being a positive integer; and
perform a weighted combination on the j account attention scores and the j direct neighbor account embedding vectors to obtain the a^{th} intermediate account neighbor representation.

17. The apparatus according to claim 16, wherein the processing circuitry is further configured to:
normalizing the j account attention scores to obtain j normalized account attention scores; and
performing a weighted combination on the j normalized account attention scores and the j direct neighbor account embedding vectors to obtain the a^{th} intermediate account neighbor representation.

18. The apparatus according to claim 14, wherein:
the target item embedding vector includes a b^{th} item embedding vector of a b^{th} item, b being a positive integer; and
the processing circuitry is further configured to:
based on the target account embedding vector, fuse a neighbor item embedding vector of a neighbor item corresponding to the b^{th} item through the item relation embedding vector to obtain a b^{th} intermediate item neighbor representation;
aggregate the b^{th} intermediate item neighbor representation and the b^{th} item embedding vector of the b^{th} item entity to obtain a b^{th} intermediate overall item representation;
update the b^{th} item embedding vector based on the b^{th} intermediate overall item representation; and
determine the b^{th} target item embedding vector as the target item representation.

19. The apparatus according to claim 18, wherein the b^{th} item includes k direct neighbor items, each of the k direct neighbor items having a direct relation with the b^{th} item; and
the processing circuitry is further configured to:
perform a feature interaction on the target account embedding vector and k direct neighbor item embedding vectors associated with the k direct neighbor items through the item relation embedding vector to obtain k item attention scores, k being a positive integer; and
perform a weighted combination on the k item attention scores and the k direct neighbor item embedding vectors to obtain the b^{th} intermediate item neighbor representation.

20. A non-transitory computer readable storage medium storing instructions which when executed by at least one processor cause the at least one processor to perform:
obtaining an account entity relation between a target account entity and a neighbor account entity of the target account entity from a knowledge graph, and an item entity relation between a target item entity and a neighbor item entity of the target item entity, the target account entity and the neighbor account entity being included in a plurality of account entities, the target item entity and the neighbor item entity being included in a plurality of item entities;
converting the plurality of account entities into a plurality of account embedding vectors, the account entity relation into an account relation embedding vector, the plurality of item entities into a plurality of item embedding vectors, and the item entity relation into an item relation embedding vector;
based on a target item embedding vector of the plurality of item embedding vectors associated with the target item entity, fusing a target account embedding vector of the plurality of account embedding vectors associated with the target account entity and a neighbor account embedding vector of the plurality of account embedding vectors associated with the neighbor account entity through the account relation embedding vector to obtain a target account representation;
based on the target account embedding vector of the plurality of account embedding vectors associated with the target account entity, fusing the target item embedding vector of the plurality of item embedding vectors associated with the target item entity and a neighbor item embedding vector of the plurality of item embedding vectors associated with the neighbor item entity through the item relation embedding vector to obtain a target item representation; and
based on a distance between the target account representation and the target item representation, determining a target item for a target account of the target account entity from the target item entity, the distance indicating a degree of matching between the target account and the determined target item.
